(19) United States
(12) Patent Application Publication
(10) Pub. No.: US 2009/0091605 A1
(43) Pub. Date: Apr. 9, 2009

(54) PRINTER INCLUDING OSCILLATORY FLUID FLOW DEVICE

(76) Inventors: Jinquan Xu, Rochester, NY (US); Zhanjun Gao, Rochester, NY (US)

Correspondence Address: David A. Novais;Patent Legal Staff, Eastman Kodak Company, 343 State Street, Rochester, NY, 14650-2201, US

(21) Appl. No.: 11/869,004

(22) Filed: Oct. 9, 2007

(51) Int. Cl. B41J 29/38; B41J 2/045

(52) U.S. Cl. 347/70; 347/9

(57) ABSTRACT

A method and printing system are provided. The printing system includes a liquid drop ejector, a fluid passage, and a fluid flow source. The liquid drop ejector is operable to eject liquid drops having a plurality of volumes along a first path. The fluid passage includes a wall. The fluid flow source is operable to cause fluid to flow in a direction through the passage. A vibrating mechanism is operably associated with the wall of the fluid passage and is configured to vibrate the wall of the fluid passage. Interaction of the fluid flow and the liquid drops causes liquids drops having one of the plurality of volumes to begin moving along a second path.

### FIELD OF THE INVENTION

This invention relates generally to the management of gas flow and, in particular to the management of gas flow in printing systems.

### BACKGROUND OF THE INVENTION

Printing systems that deflect drops using a gas flow are known; see, for example, U.S. Pat. No. 4,068,241, issued to Yamada, on Jan. 10, 1978.

The device that provides gas flow to the gas flow drop interaction area can introduce turbulence in the gas flow that may augment and ultimately interfere with accurate drop deflection or divergence. Turbulent flow introduced from the gas supply typically increases or grows as the gas flow moves through the structure or plenum used to carry the gas flow to the gas flow drop interaction area of the printing system.

Drop deflection or divergence can be affected when turbulence, the randomly fluctuating motion of a fluid, is present in, for example, the interaction area of the drops (traveling along a path) and the gas flow force. The effect of turbulence on the drops can vary depending on the size of the drops. For example, when relatively small volume drops are caused to deflect or diverge from the path by the gas flow force, turbulence can randomly disorient small volume drops resulting in reduced drop deflection or divergence accuracy which, in turn, can lead to reduced drop placement accuracy.

Research has been conducted to examine the effect of wall oscillation on airflow. W. Jung, N. Mangiavacchi and R. Akhavan (“Suppression of Turbulence in Wall-Bounded Flows by High-Frequency Spanwise Oscillations”, Phys. Fluids A 4(8), August, 1992, p 1605-1607) conducted numerical simulations of a planar channel flow subjected either to an oscillatory spanwise cross-flow or to the spanwise oscillatory motion of a channel wall. In the case they considered, it showed a reduction of 10% to 40% in turbulent drag. D. Zhou and K. Ball (“The Mechanism of Turbulent Drag Reduction by Spanwise Wall Oscillation”, 42nd AIAA/ASME/SAE/ASEE Joint Propulsion Conference & Exhibit, 9-12 Jul. 2006, Sacramento, Calif. Its official number is AIAA 2006-4579) investigated the mechanism of drag reduction by examining the effect of spanwise wall oscillation as a control scheme of turbulent drag reduction on the turbulent statistics and the instantaneous flow fields. Recently, M. Jovanovic (“Turbulence Suppression in Channel Flows by Small Amplitude Transverse Wall Oscillations”, In Proceedings of the 2006 American Control Conference, Minneapolis, Minn., pages 1161-1166) modeled the influence of small amplitude transverse wall oscillations on the evolution of velocity perturbations in channel flow. The above described studies were, however, confined to academia research of simplified, ideal channel flow with no specific device contemplated.

Accordingly, a need exists to reduce turbulent gas flow in the gas flow drop interaction area of a printing system.

### SUMMARY OF THE INVENTION

According to one aspect of the invention, a printing system includes a liquid drop ejector, a fluid passage, and a fluid flow source. The liquid drop ejector is operable to eject liquid drops having a plurality of volumes along a first path. The fluid passage includes a wall. The fluid flow source is operable to cause fluid to flow in a direction through the passage. A vibrating mechanism is operably associated with the wall of the fluid passage and is configured to vibrate the wall of the fluid passage. Interaction of the fluid flow and the liquid drops causes liquids drops having one of the plurality of volumes to begin moving along a second path.

According to another aspect of the invention, a method of printing includes providing drops having a plurality of volumes traveling along a first path; providing a passage including a wall; causing a fluid to flow in a direction through the passage; causing the wall of the passage to vibrate; and causing the fluid flow to interact with the liquid drops such that liquid drops having one of the plurality of volumes to begin moving along a second path.

### BRIEF DESCRIPTION OF THE DRAWINGS

In the detailed description of the example embodiments of the invention presented below, reference is made to the accompanying drawings, in which:

FIG. 1 is a three dimensional schematic view of a printing system incorporating an example embodiment of a vibration mechanism of the present invention;

FIG. 2 is a two dimensional schematic view of a printing system incorporating an example embodiment of a vibration mechanism of the present invention;

FIG. 3 is a two dimensional schematic view of a printing system incorporating an example embodiment of a vibration mechanism and passage wall with a perforated portion of the present invention;

FIGS. 4A, 4B, 4C are schematic views of the details of the perforated portion of the passage wall of the present invention;

FIG. 5A is a two dimensional schematic view of a printing system incorporating a piezoelectric actuator in the normal mode of the present invention, and

FIG. 5B is a two dimensional schematic view of a printing system incorporating a piezoelectric actuator in the shear mode of the present invention.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

The example embodiments of the present invention are illustrated schematically and not to scale for the sake of clarity. One of ordinary skill in the art will be able to readily determine the specific size and interconnections of the elements of the example embodiments of the present invention. In the following description, identical reference numerals have been used, where possible, to designate identical elements.

Although the term printing system is used herein, it is recognized that printing systems are being used today to eject other types of liquids and not just ink. For example, the ejection of various fluids such as medicines, inks, pigments, dyes, and other materials is possible today using printing systems. As such, the term printing system is not intended to be limited to just systems that eject ink.

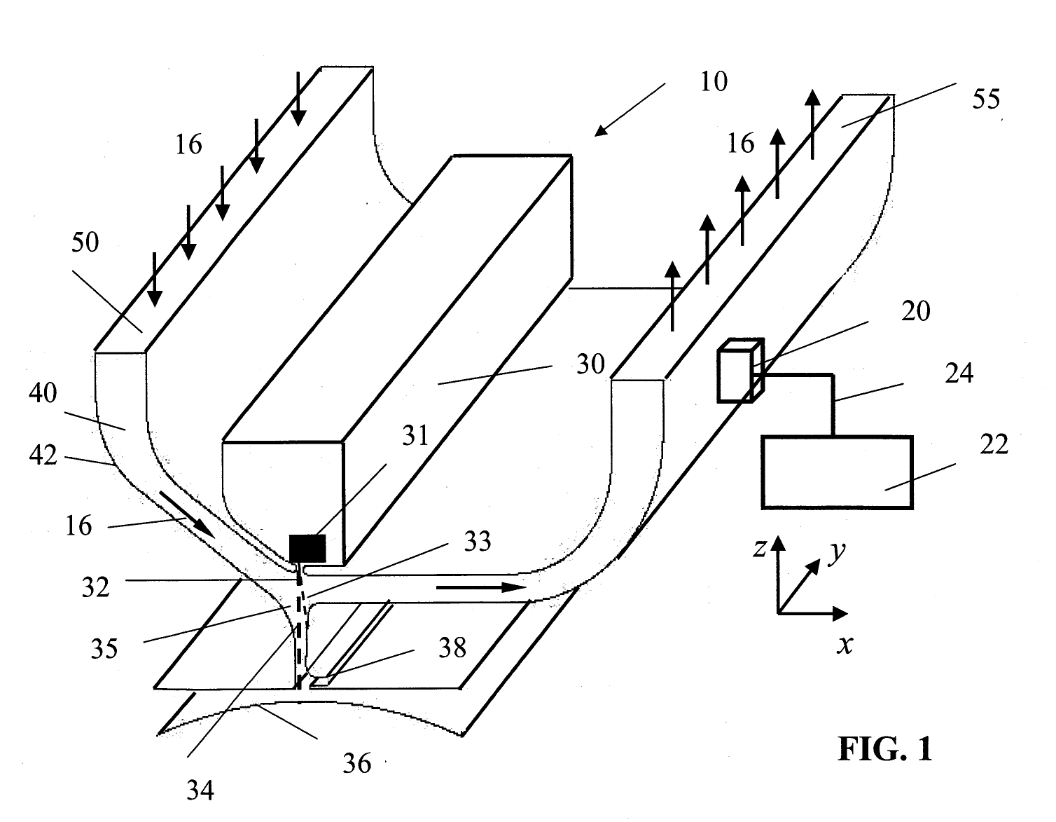

Referring to FIG. 1, a schematic view of a printing system 10 incorporating a vibration mechanism 20 is shown. Printing system 10 includes a liquid drop ejector or printhead 30 positioned to eject drops 32 through passage 35. At least some the drops 32 contact a receiver 36 while other drops are collected by a catcher 38.

A fluid flow 16 is provided through fluid passage 40 with wall 42. Printhead 30 includes a drop forming mechanism 31 operable to form drops 32 having a plurality of volumes traveling along a first path. The fluid flow 16 is applied in a direction such that drops having one of the plurality of volumes diverge (or deflect) from the first path (represented by a dashed line that drops 32 travel along) and begin traveling along a second path 33 while drops having another of the plurality of volumes remain traveling substantially along the first path or diverge (deflect) slightly and begin traveling along a third path 34.

Receiver 36 is positioned along one of the first, second, and third paths while catcher 38 is positioned along another of the first, second and third paths depending on the specific application contemplated. Printheads like printhead 30 are known and have been described in, for example, U.S. Pat. No. 6,457,807 B1, issued to Hawkins et al., on Oct. 1, 2002; U.S. Pat. No. 6,491,362 B1, issued to Jeanmaire, on Dec. 10, 2002; U.S. Pat. No. 6,505,921 B2, issued to Chwalek et al., on Jan. 14, 2003; U.S. Pat. No. 6,554,410 B2, issued to Jeanmaire et al., on Apr. 29, 2003; U.S. Pat. No. 6,575,566 B1, issued to Jeanmaire et al., on Jun. 10, 2003; and U.S. Pat. No. 6,588,888 B2, issued to Jeanmaire et al., on Jul. 8, 2003.

After being ejected by the drop forming mechanism 31 of printhead 30, drops 32 travel along the first path which is substantially perpendicular to printhead 30. The fluid flow source 16 is operatively associated with one or both of the inlet portion 50 and the outlet portion 55. For example, pressurized gas (e.g. air) from a pump can be introduced in the inlet portion 50 and/or a vacuum (negative air pressure relative to ambient operating conditions) from a vacuum pump can be introduced in the outlet portion 55. When fluid flow sources like these are introduced on the inlet portion 50 and the outlet portion 55 a sink for the fluid or gas flow is provided. The fluid or gas flow (represented by arrows 16) of the drop deflector interacts with ejected drops 32 and causes drops 32 to diverge or deflect as described above. The amount of deflection is volume dependent with smaller volume drops being deflected by the fluid or gas flow more than larger volume drops.

The vibration mechanism 20 is attached to the printing system 10, and connected in electrical communication with and is electrically controlled by a controller 22 over a conductive path 24. The vibration mechanism 20 can cause the printing system 10 to vibration in x, y or z direction.

In one example embodiment of this invention, the vibration mechanism 20 is arranged to cause the printing system 10 to vibrate along the span-wise direction of fluid flow 16. The span-wise direction is the same as the y-axis direction of the Cartesian coordinate system shown in FIG. 1. Such a high-frequency oscillations of the flow channel can suppress turbulence in droplet deflection zone. Current research results show that reductions of 10% to 40% in turbulence intensities can be achieved for certain values of oscillation frequencies. Suppression of turbulence by span-wise wall oscillations is due to decreased variance amplification compared to the uncontrolled airflow. In other words, the wall oscillation induced changes in nominal velocity constrain velocity perturbations to experience smaller stochastic amplification rates.

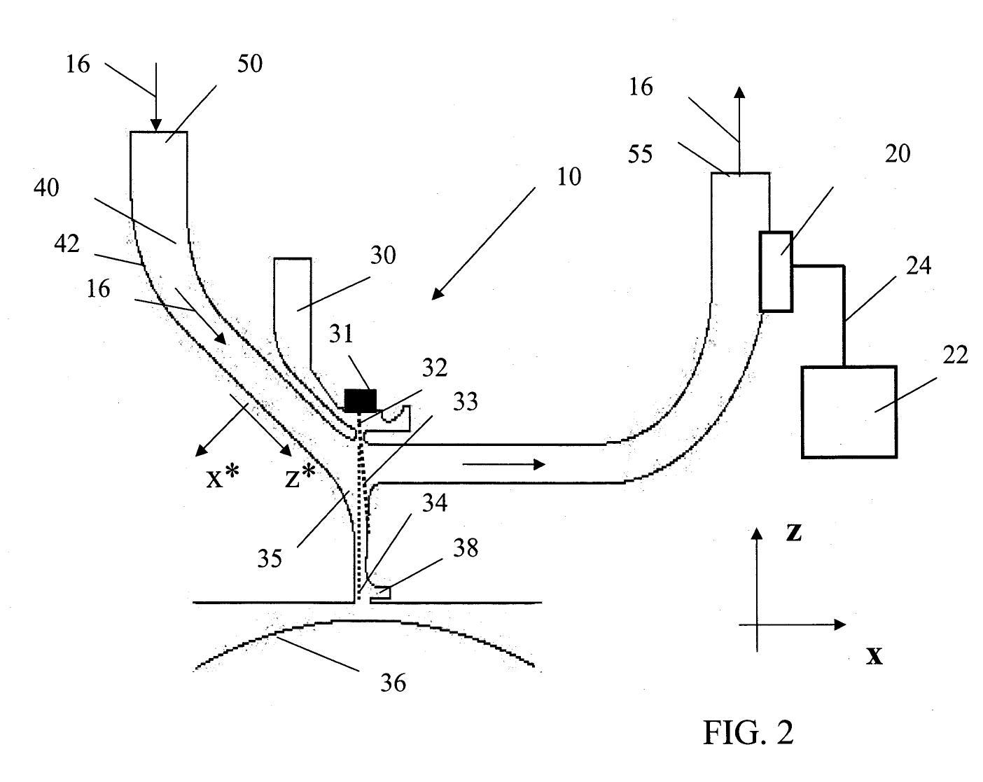

The vibration mechanism 20 can also be devised to cause the printing system 10 to vibrate along other directions to break down the boundary layer flow to delay the onset of turbulent flow near the passage 35. FIG. 2 is a two-dimensional view of the printhead shown in FIG. 1. In FIG. 2, a new Cartesian coordinate system x*-z* is introduced. The z* direction is parallel to the wall 42 of fluid passage 40 near the drops 32. The x* direction is perpendicular to the wall 42 of fluid passage 40 near the drops 32. The y* direction is perpendicular to the x*-z* plane. In one example embodiment of this invention, the vibration mechanism 20 is devised to cause the printing system 10 to vibrate in the z*-y* plane, along the z* direction. In another example embodiment, the vibration mechanism 20 is devised to cause the printing system 10 to vibrate in the x*-y* plane, along the x* direction.

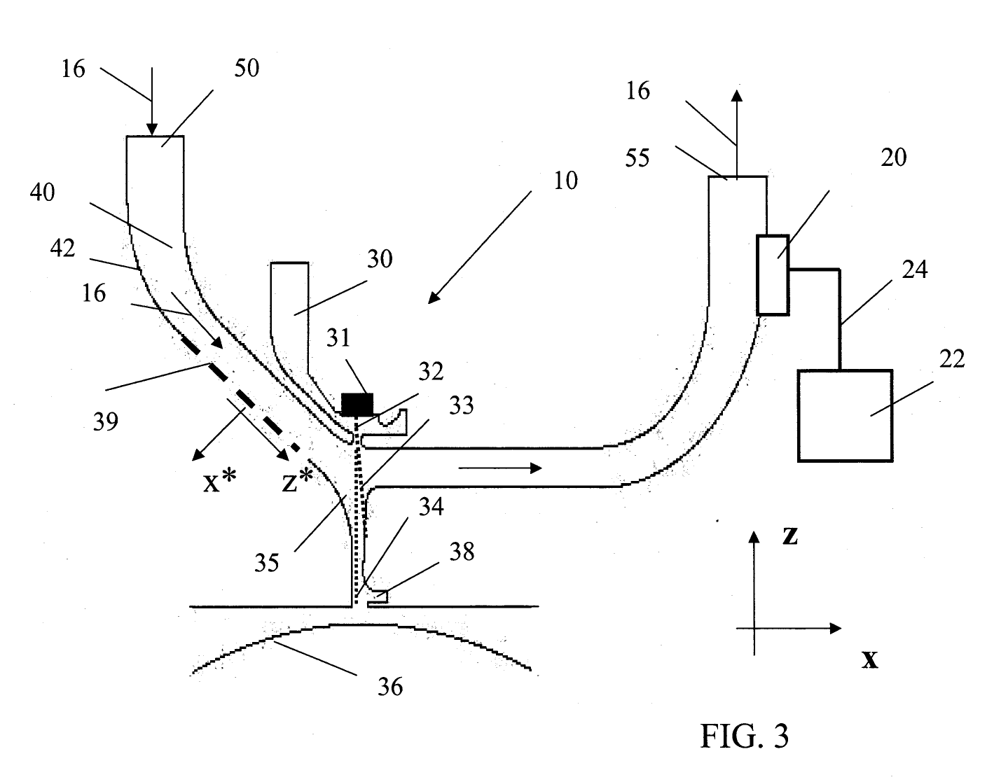

The example embodiment shown in FIGS. 1 and 2 can also be extended to include a wall with a perforated portion like the perforated wall portion described in U.S. patent application Ser. No. 11/770,804. FIG. 3 is a schematic side view of a printing system with the vibration mechanism incorporating an example embodiment of the present invention and walls including a perforated portion 39. As shown in FIG. 3, wall 42 of page 40 includes a perforated portion 39. The perforated portion 39 of the fluid passage 40 is located adjacent to the first path 34.

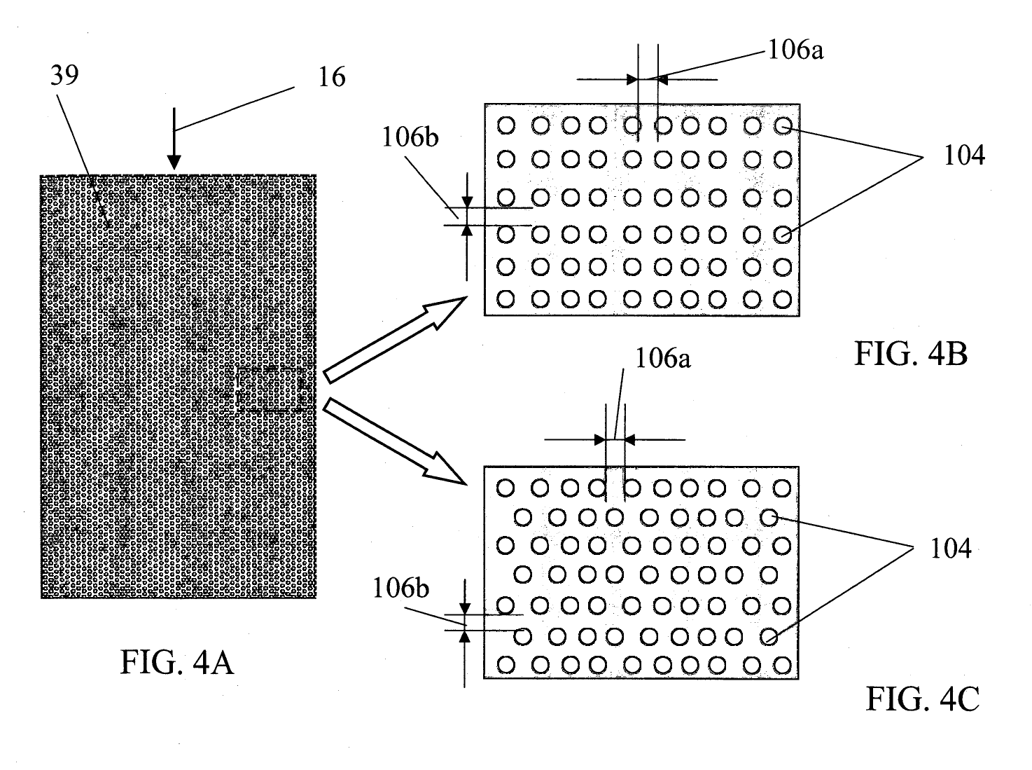

FIG. 4A shows the perforated portion 39 of wall 42. A fluid flow 16 flows in a direction along the perforated portion of the wall of a passage. The perforated portion includes a plurality of holes. FIG. 4B shows the plurality of holes 104 arranged in an aligned two dimensional array. FIG. 4C shows the plurality of holes 104 arranged in a staggered two dimensional array. The holes 104 can be cut by technology such as laser beams, chemical etching, or electroform. The wall material can be tantalum, silicon, stainless steel, aluminum, or nickel etc., depending wall mechanical integrity requirement and perforation manufacture technology available.

The thickness of the wall, preferably to be thin, for example, 300 micrometer. The diameters of holes 104 are around 10-50 micrometers. Spacings 106a perpendicular to the direction of the fluid flow 16 between holes 104 are roughly around 40-100 micrometers, depending on printing drop resolution. Spacings 106b parallel to the direction of the fluid flow 16 are roughly around 40-100 micrometers, determined by the flow rate of the fluid flow 16 in the passage. The shape of the holes 104 can be circular, elliptic, square or even irregular shapes such as triangular. However, circular shapes are preferred for at least manufacturability reasons.

In the example embodiment shown in FIG. 3, the vibration mechanism 20 is positioned and operated to cause the printing system 10 to vibrate along the span-wise direction of fluid flow 16 similar to the example embodiment shown in FIG. 1. Such a high-frequency oscillations of the flow channel, combined with a secondary flow through the perforated portion 39, can suppress turbulence in droplet deflection zone.

Alternatively, the vibration mechanism 20 shown in FIG. 3 can be positioned and operated to cause the printing system 10 to vibrate along other directions to break down the boundary layer flow to delay the onset of turbulent flow near the passage 35 similar to the example embodiment shown in FIG. 2. For example, the vibration mechanism 20 can be operated to cause the printing system 10 to vibrate in the z*-y* plane, along the z* direction. Alternatively, the vibration mechanism 20 can be positioned and operated to cause the printing system 10 to vibrate in the x*-y* plane, along the x* direction.

The vibration mechanism 20 of the present invention can be any suitable commercially available vibration actuator. For example, vibration mechanism 20 can be vibration actuators such as those disclosed in U.S. Pat. No. 6,812,618, U.S. Pat. No. 6,724,607, and U.S. Pat. No. 6,242,846. However, other types of vibration actuators can be used.

Magnetic actuators and piezoelectric actuators are particularly suitable for use in the present invention. A magnetic actuator utilizes magnetostrictive materials to convert magnetic energy to mechanical energy and vice versa. As a magnetostrictive material is magnetized, it strains; that is it exhibits a change in length per unit length. Conversely, if an external force produces a strain in a magnetostrictive material, the material's magnetic state will change. This bi-directional coupling between the magnetic and mechanical states of a magnetostrictive material provides a transduction capability that is used for both actuation and sensing devices. Magnetostriction is an inherent material property that will not degrade with time.

In many devices, conversion between electrical and magnetic energies facilitates device use. This is most often accomplished by sending a current through a wire conductor to generate a magnetic field or measuring current induced by a magnetic field in a wire conductor to sense the magnetic field strength. Hence, most magnetostrictive devices are in fact electro-magneto-mechanical transducers.

A piezoelectric actuator works on the principle of piezoelectricity. Piezoelectricity is the ability of crystals and certain ceramic materials to generate a voltage in response to applied mechanical stress. The piezoelectric effect is reversible in that piezoelectric crystals, when subjected to an externally applied voltage, can change shape by a small amount. (For instance, the deformation is about 0.1% of the original dimension in PZT.) The effect finds useful applications such as the production and detection of sound, generation of high voltages, electronic frequency generation, microbalance, and ultra fine focusing of optical assemblies. A break through was made in the 1940's when scientists discovered that barium titanate could be bestowed with piezoelectric properties by exposing it to an electric field.

Piezoelectric materials are used to convert electrical energy to mechanical energy and vice-versa. The precise motion that results when an electric potential is applied to a piezoelectric material is of primordial importance for nanopositioning. Actuators using the piezo effect have been commercially available for approximately 35 years and in that time have transformed the world of precision positioning and motion control. Piezo actuators can perform sub-nanometer moves at high frequencies because they derive their motion from solid-state crystalline effects. They have no rotating or sliding parts to cause friction. Piezo actuators can move high loads, up to several tons. Piezo actuators present capacitive loads and dissipate virtually no power in static operation. Piezo actuators require little or no maintenance and are not subject to wear because they have no moving parts in the classical sense of the term.

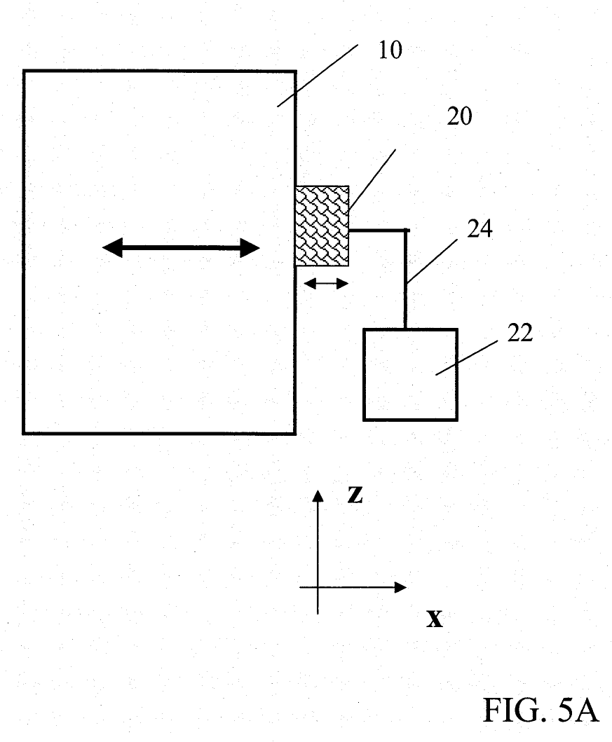

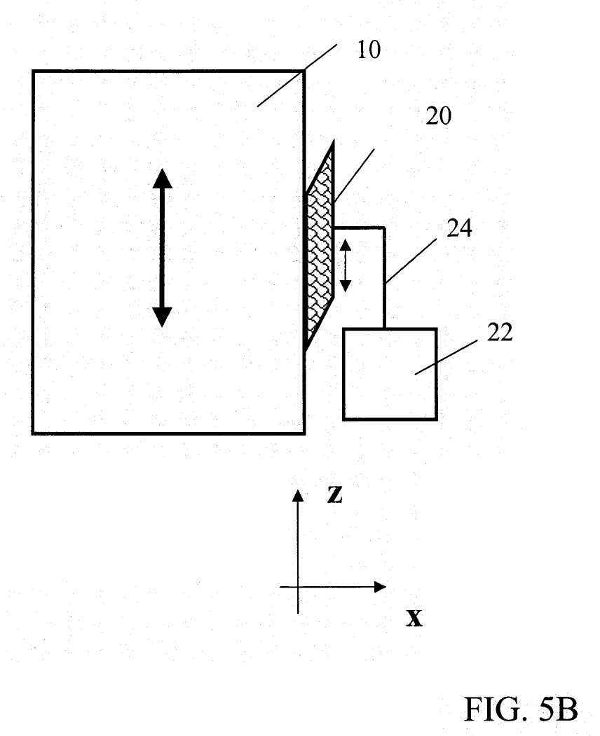

The vibration mechanism 20 in the present invention can utilize piezoelectric material where the poling axis of the material is directed from one electrode to the other. Such a configuration is a thickness mode (normal mode) actuator. When the voltage is applied between the electrodes, the thickness of the piezoelectric will change, resulting a relative displacement of up to 0.2%. Displacement of the piezoelectric actuator is primarily a function of the applied electric field of strength and the length of the actuator, the forced applied to it and the property of the piezoelectric material used. With the reverse field, negative expansion (Contraction) occurs. If both the regular and reverse fields are used, a relative expansion (strain) up to 0.2% is achievable with piezo stack actuators. In FIG. 5A, the normal mode piezoelectric actuator 20 is utilized which causes the vibration of printing system 10 along the x-axis direction.

Shear mode piezoelectric actuators can also be used for the present invention. In shear mode piezoelectric actuators, the poling axis of the material is oriented parallel to the plane of the electrodes, not perpendicular as in the thickness mode. When a voltage is applied across the electrodes, shearing forces are produced in the material to cause the material to deform, with the material assuming a parallelogram shape. When such an actuator is driven by an AC voltage, the shearing action produces a vibration in one direction. As the length and width of the piezoelectric are unaffected by the shearing action, the shear mode actuators have no tendency to induce vibrations in other directions. In FIG. 5B, the shear mode piezoelectric actuator 20 is utilized which causes the vibration of printing system 10 along the x-axis direction.

The invention has been described in detail with particular reference to certain example embodiments thereof, but it will be understood that variations and modifications can be effected within the scope of the invention.

### PARTS LIST

10 printing system
16 fluid flow
20 vibration mechanism
22 controller
24 conductive path
30 printhead
31 drop forming mechanism
32 drops
33 second path
34 third path
35 passage
36 receiver
38 catcher
39 perforated portion
40 fluid passage
42 wall
50 inlet portion
55 outlet portion
104 holes
106a spacing
106b spacing

1. A printing system comprising:
a liquid drop ejector operable to eject liquid drops having a plurality of volumes along a first path;
a fluid passage including a wall;
a fluid flow source operable to cause fluid to flow in a direction through the passage;
a vibrating mechanism operably associated with the wall of the fluid passage, the vibrating mechanism being configured to vibrate the wall of the fluid passage, wherein interaction of the fluid flow and the liquid drops causes liquids drops having one of the plurality of volumes to begin moving along a second path.

2. The system of claim 1, wherein the vibrating mechanism is a piezoelectric actuator attached to the wall of the fluid passage.

3. The system of claim 2, further comprising:
a controller configured to operate the piezoelectric actuator in a shear mode.

4. The system of claim 2, further comprising:
a controller configured to operate the piezoelectric actuator in a normal mode.

5. The system of claim 1, wherein the passage is straight.

6. The system of claim 1, wherein the vibrating mechanism is configured to vibrate the wall in a direction transverse to the direction of fluid flow.

7. A method of printing comprising:
providing drops having a plurality of volumes traveling along a first path;
providing a passage including a wall;
causing a fluid to flow in a direction through the passage;
causing the wall of the passage to vibrate; and
causing the fluid flow to interact with the liquid drops such that liquid drops having one of the plurality of volumes to begin moving along a second path.

8. The method of claim 7, wherein causing the wall of the passage to vibrate includes causing the wall of the passage to vibrate in a direction transverse to the direction of fluid flow.

9. The method of claim 7, wherein causing the wall of the passage to vibrate includes causing the wall of the passage to vibrate in the spanwise direction relative to the direction of fluid flow.

10. The method of claim 7, wherein causing the wall of the passage to vibrate includes causing the wall of the passage to vibrate in the direction of the fluid flow.

11. The method of claim 7, wherein causing the wall of the passage to vibrate includes operating a piezoelectric actuator attached to the wall in a shear mode.

12. The method of claim 7, wherein causing the wall of the passage to vibrate includes operating a piezoelectric actuator attached to the wall in a normal mode.

13. The method of claim 7, wherein causing the wall to vibrate includes causing the wall to vibrate in a stream-wise direction.
